(19) United States
(12) Patent Application Publication
(10) Pub. No.: US 2021/0300430 A1
(43) Pub. Date: Sep. 30, 2021

(54) APPARATUS FOR SWITCHING CONTROL AUTHORITY OF AUTONOMOUS VEHICLE AND METHOD THEREOF

(71) Applicants: Hyundai Motor Company, Seoul (KR); Kia Motors Corporation, Seoul (KR)

(72) Inventor: Dong Hoon Kang, Seoul (KR)

(21) Appl. No.: 17/093,909

(22) Filed: Nov. 10, 2020

(30) Foreign Application Priority Data
Mar. 26, 2020 (KR) 10-2020-0037051

(51) Int. Cl. B60W 60/00; B60W 40/09; B60W 30/18; G06N 20/00

(52) U.S. Cl. CPC B60W 60/0053; B60W 40/09; B60W 30/18; B60W 2040/0809; B60W 2540/30; B60W 2556/10; G06N 20/00

(57) ABSTRACT

An apparatus for switching driving control authority of an autonomous vehicle and a method thereof are provided to deeply learn a normal driving pattern of the autonomous vehicle corresponding to a driving situation, detect a matching degree of the driving pattern of a driver based on the deep learning result, and determine whether to retrieve the driving control authority of the driver corresponding to the detected matching degree. Accordingly, the driving control authority of the driver is retrieved to prevent an accident in advance even if there is no request to activate an autonomous driving mode of the driver.

### CROSS-REFERENCE TO RELATED APPLICATION

This application claims the benefit of priority to Korean Patent Application No. 10-2020-0037051, filed on Mar. 26, 2020, the entire contents of which are incorporated herein by reference.

### TECHNICAL FIELD

The present disclosure relates to a technique for switching driving control authority of an autonomous vehicle based on deep learning.

### BACKGROUND

In general, deep learning (or a deep neural network), which is a type of machine learning, may include artificial neural networks (ANNs) of several layers between an input and an output. Such an artificial neural network may include a convolutional neural network (CNN) or a recurrent neural network (RNN) according to a structure, a problem, a purpose to be solved, and the like. The deep learning is used to solve various problems such as classification, regression, localization, detection, segmentation, and the like.

Meanwhile, the autonomous vehicle itself recognizes a road environment, determines a driving situation, and operates various systems in the vehicle, including a steering device, to move from a current location to a target location along the planned driving route. The autonomous vehicle may include an autonomous emergency braking (AEB) system, a forward collision warning (FCW) system, an adaptive cruise control (ACC) system, a lane departure warning system, LDWS), a lane keeping assist system (LKAS), a blind spot detection (BSD) apparatus, a rear-end collision warning (RCW) system, a smart parking assist system (SPAS), and the like.

Since current autonomous driving technology requires a human intervention in a special situation that is not fully autonomous driving, the autonomous driving technology is implemented to be able to switch the driving control authority of an autonomous vehicle between the autonomous driving system and a driver. When a request from a driver for activation of an autonomous driving mode is received, a conventional technology for switching the driving control authority of an autonomous vehicle determines whether an operational design domain (ODD) condition is met. When the ODD condition is met, the autonomous driving mode is activated. When the ODD condition is not met, the autonomous driving mode is deactivated.

The intervention of a driver may prevent an accident in a special situation, but in most cases, considering that the driving of the autonomous driving system is safer than the driving control of a driver, since conventional technology retrieves the driving control authority of a driver in response to only the request of the driver, the autonomous driving mode is unable to be activated in emergency, thus making it difficult to prevent an accident.

The matters described in this section are merely intended to promote an understanding of the background of the disclosure and may include matters that are not already known to those of ordinary skill in in the art.

### SUMMARY

The present disclosure provides an apparatus for switching driving control authority of an autonomous vehicle and a method thereof which are capable of deep learning a normal driving pattern of the autonomous vehicle corresponding to a driving situation, detecting a matching degree of the driving pattern of a driver based on the deep learning result, and determining whether to retrieve the driving control authority of the driver corresponding to the detected matching degree, such that the driving control authority of the driver is retrieved to prevent an accident in advance even if there is no request to activate an autonomous driving mode of the driver.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for switching driving control authority of an autonomous vehicle may include a learning device configured to deeply learn a normal driving pattern of the autonomous vehicle corresponding to a driving situation, and a controller configured to determine whether to retrieve the driving control authority of a driver based on a learning result of the learning device. The apparatus may further include a storage configured to store a normal driving pattern model as the learning result of the learning device.

The controller may be configured to detect a matching degree indicating how much a driving pattern of the driver matches the normal driving pattern model (e.g., a matching degree), and retrieve the driving control authority of the driver when the detected matching degree is less than a first reference value. The controller may be configured to retrieve the driving control authority of the driver when an operational design domain (ODD) condition is met. The controller may be configured to correct a driving control value of the driver when the detected matching degree exceeds the first reference value but is less than a second reference value. The controller may also be configured to correct a lateral control value of the driver. The controller may be configured to correct a longitudinal control value of the driver.

According to an aspect of the present disclosure, a method of switching driving control authority of an autonomous vehicle may include deeply learning, by a learning device, a normal driving pattern of the autonomous vehicle corresponding to a driving situation, and determining, by a controller, whether to retrieve the driving control authority of a driver based on a learning result of the learning device. The method may further include storing, by a storage, a normal driving pattern model as the learning result of the learning device.

The method may include detecting a matching degree that indicates how much a driving pattern of the driver matches the normal driving pattern model, and retrieving the driving control authority of the driver when the detected matching degree is less than a first reference value. The method may include determining whether an operational design domain (ODD) condition is met, and retrieving the driving control authority of the driver when the ODD condition is met and the detected matching degree is less than exceed a first reference value. Additionally, the method may include correcting a driving control value of the driver when the detected matching degree exceeds the first reference value but is less than a second reference value. The method may include correcting a lateral control value of the driver and correcting a longitudinal control value of the driver.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for switching control authority of an autonomous vehicle according to an exemplary embodiment of the present disclosure;

FIG. 2 is a view illustrating a detailed structure of a learning device provided in an apparatus for switching control authority of an autonomous vehicle according to an exemplary embodiment of the present disclosure;

FIG. 3 is a flowchart illustrating a method of switching control authority of an autonomous vehicle according to an exemplary embodiment of the present disclosure; and

FIG. 4 is a block diagram illustrating a computing system for executing a method of switching control authority of an autonomous vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of well-known features or functions will be ruled out in order not to unnecessarily obscure the gist of the present disclosure.

In describing the components of the exemplary embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

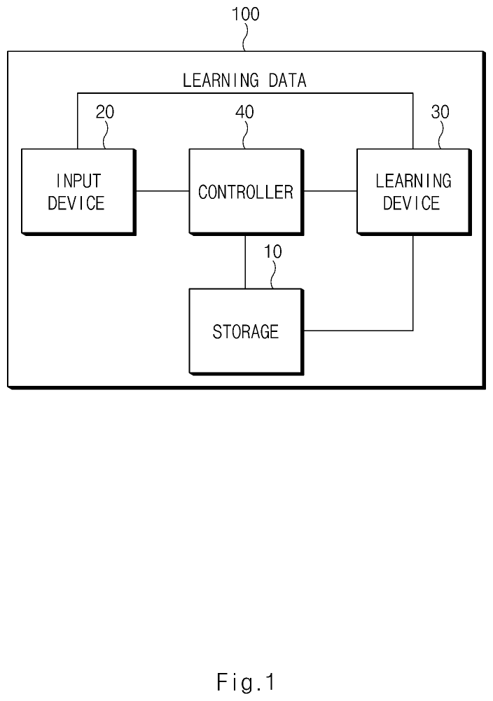

FIG. 1 is a block diagram illustrating a configuration of an apparatus for switching control authority of an autonomous vehicle according to an exemplary embodiment of the present disclosure. As shown in FIG. 1, an apparatus 100 for switching control authority of an autonomous vehicle according to an exemplary embodiment of the present disclosure may include storage 10, an input device 20, a learning device 30, and a controller 40. In particular, according to a scheme of implementing the apparatus 100 for switching control authority of an autonomous vehicle according to an exemplary embodiment of the present disclosure, each component may be combined with each other to be implemented as one, and some components may be omitted.

Regarding each component, first, the storage 10 may be configured to store various logic, algorithms and programs required in the processes of deep learning a normal driving pattern of the autonomous vehicle corresponding to a driving situation, detecting a matching degree of the driving pattern of a driver based on the deep learning result, and determining whether to retrieve the driving control authority of a driver corresponding to the detected matching degree. The storage 10 may be configured to store a normal driving pattern model (an artificial neural network in which deep learning is completed) as a result of deep learning the nominal driving pattern of the autonomous vehicle in accordance with a driving situation. In particular, the normal driving pattern model may be provided for each driving situation (e.g., a situation in which another vehicle cuts in, a situation in which a preceding vehicle stops suddenly).

The storage 10 may be configured to store a first reference value (e.g., 0.5) as a matching degree value that is a reference for determining whether to retrieve the driving control authority of a driver. In particular, when the matching degree value is 1, it means that the normal driving pattern model and the driving pattern of the driver match. The storage 10 may be configured to store a second reference value (e.g., 0.7) as the matching degree value that is a criterion for determining whether to correct the driving control (longitudinal control, lateral control) of the driver without retrieving the driving control authority of the driver.

The storage 10 may be configured to store an operational design domain (ODD) condition which is a technique well-known in the art. The storage 10 may include at least one type of a storage medium of memories of a flash memory type, a hard disk type, a micro type, a card type (e.g., a secure digital (SD) card or an extreme digital (XD) card), and the like, and a random access memory (RAM), a static RAM (SRAM), a read-only memory (ROM), a programmable ROM (PROM), an electrically erasable PROM (EEPROM), a magnetic memory (MRAM), a magnetic disk, and an optical disk type memory.

The input device 20 may be configured to input learning data to the learning device 30 in the process of learning the normal driving pattern of the autonomous vehicle in accordance with the driving situation. In particular, the learning data include various sensor data for each driving situation (line information, a speed of the autonomous vehicle, a heading angle of the autonomous vehicle, a location (relative position) of a nearby vehicle based on the autonomous vehicle, a speed of the nearby vehicle, and a driving trajectory of the nearby vehicle, a driving control (longitudinal control, lateral control) value of the driver), and the like.

The input device 20 may be configured to input the sensor data at the current time point to the controller 40 in the process of determining whether to retrieve the driving control authority of the driver. The input device 20 may include a light detection and ranging (LiDAR) sensor, a camera, a radio detecting and ranging (RaDAR) sensor, a V2X module, a global positioning system (GPS) receiver, and a precise map. The LiDAR sensor, which is a type of environmental recognition sensor, may be mounted on an autonomous vehicle to measure the positional coordinates of a reflector based on the time taken for the laser to return after being shot in all directions while rotating and being reflected back.

The camera may be mounted on an autonomous vehicle and photographs an image including lines, vehicles, people, and the like located in the vicinity of the autonomous vehicle. The radar sensor may be configured to receive electromagnetic waves reflected from an object after radiating the electromagnetic waves to measure the distance to the object, the direction of the object, and the like. Such a radar sensor may be mounted on the front bumper and the rear side of an autonomous vehicle, and may be configured to recognize long-range objects without being influenced by weather.

The V2X module may include a vehicle to vehicle (V2V) module and a vehicle to infrastructure (V2I) module. The V2V module may be configured to communicate with a nearby vehicle to obtain the location, speed, acceleration, yaw rate, traveling direction, and the like of the nearby vehicle. The V2I module may be configured to obtain a shape of a road, a surrounding structure, and traffic signal light information (the location, and lighting state (red, yellow, green, and the like)) from the infrastructure.

The GPS receiver may be configured to receive GPS signals from three or more GPS satellites. The precise map, which is a map for autonomous driving, may include information about lines, traffic signal lights, sign boards, and the like to more accurately measure the location of an autonomous vehicle and to enhance the safety of an autonomous vehicle. Since the precise map itself is a technique well-known in the art, the detailed description will be omitted. The learning device 30 may be configured to perform deep learning based on the learning data input from the input device 20, and as a result, generate a normal driving pattern model. The normal driving pattern model may be implemented as a recurrent neural network (RNN) or a long short-tem memory (LSTM). The normal driving pattern model may be configured to output a matching degree of a driver driving pattern corresponding to sensor data at the current time point.

The controller 40 may be configured to execute the overall control such that each component may perform its functions normally. The controller 40 may be implemented in the form of hardware or software, or may be implemented in the form of a combination of hardware and software. In particular, the controller 40 may be implemented with a microprocessor, but is not limited thereto. The controller 40 may be configured to perform various control in the operations of deep learning a normal driving pattern of the autonomous vehicle corresponding to a driving situation, detecting a matching degree of the driving pattern of a driver based on the deep learning result, and determining whether to retrieve the driving control authority of a driver corresponding to the detected matching degree.

The controller 40 may be configured to operate the learning device 30 to generate a normal driving pattern model by deep learning the normal driving pattern of the autonomous vehicle in accordance with the driving situation. The controller 40 may be configured to detect the matching degree of the driving pattern of the driver based on the normal driving pattern model. In particular, the controller 40 may be configured to input the sensor data at the current time point into the normal driving pattern model to detect the matching degree of the driving pattern of the driver. The matching degree is a value indicating how much the driving pattern of the driver matches the normal driving pattern, where value ‘1’ indicates a perfect match and value ‘0’ indicates no match.

The controller 40 may be configured to retrieve the driving control authority of the driver when the matching degree of the driving pattern of the driver is less than the first reference value (e.g., 0.5). When the driving control authority of the driver is retrieve as described above, the autonomous vehicle may operate in the autonomous driving mode. It may assumed that the ODD condition is met.

The controller 40 may be configured to determine whether or not to release a dangerous situation (e.g., a situation in which another vehicle cuts in, a situation in which a preceding vehicle stops suddenly) after retrieving the driving control authority of the driver. The controller 40 may be configured to maintain the autonomous driving mode when the dangerous situation is not canceled, and determine the driver's intention to drive when the dangerous situation is canceled. In particular, the driver's intention to drive may include the driver's steering wheel manipulation, the driver's brake pedal manipulation, the driver's accelerator pedal manipulation, and the like. The controller 40 may be configured to maintain the autonomous driving mode when the driver does not intend to drive, and may be configured to transfer the driving control authority when the driver does not intend to drive.

The controller 40 may be configured to correct a driving control value of the driver when the matching degree of the driving pattern of the driver exceeds the first reference value but is less than the second reference value (e.g., about 0.7). For example, the controller 40 may be configured to perform a lateral correction that allows the autonomous vehicle to move to the center of an lane when the autonomous vehicle leaves the center of the lane, and when the distance from a preceding vehicle exceeds a safety distance, the controller 40 may be configured to perform a longitudinal correction that maintains the safe distance by engaging the brakes on the autonomous vehicle.

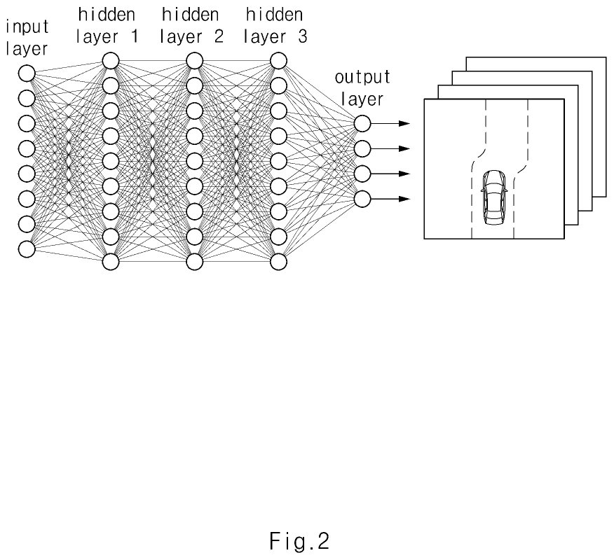

FIG. 2 is a view illustrating a detailed structure of a learning device provided in an apparatus for switching control authority of an autonomous vehicle according to an exemplary embodiment of the present disclosure. As illustrated in FIG. 2, the learning device 30, which is provided in an apparatus for switching control authority of an autonomous vehicle according to an exemplary embodiment of the present disclosure, may include an input layer, three hidden layer (e.g., hidden layer 1, hidden layer 2 and hidden layer 3) and an output layer. In particular, the output layer may be configured to output a plurality of normal driving patterns (e.g., a normal driving pattern for each driving situation). The input layer may be input at least one of a speed of the autonomous vehicle, a heading angle of the autonomous vehicle, a location (relative position) of a nearby vehicle based on the autonomous vehicle, a speed of the nearby vehicle, and a driving trajectory of the nearby vehicle, a driving control value (e.g., longitudinal control value, lateral control value) of the driver. The output layer.

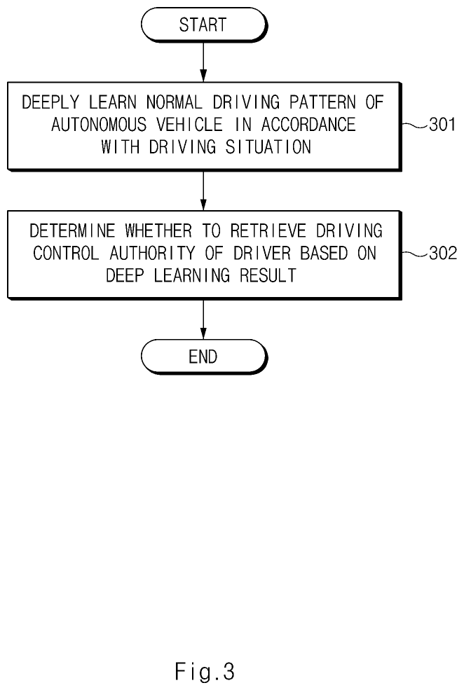

FIG. 3 is a flowchart illustrating a method of switching control authority of an autonomous vehicle according to an exemplary embodiment of the present disclosure. First, in operation 301, the leaning device 30 may be configured to deeply learn the normal driving pattern of the autonomous vehicle corresponding to the driving situation. Thereafter, in operation 302, the controller 40 may be configured to determine whether to retrieve the driving control authority of the driver based on the deep leaning result. The controller 40 may be configured to detect the matching degree that indicates how much the driving pattern of the driver matches the normal driving pattern model, and in response to determining that the detected matching degree is less than the first reference value, retrieve the driving control authority of the driver.

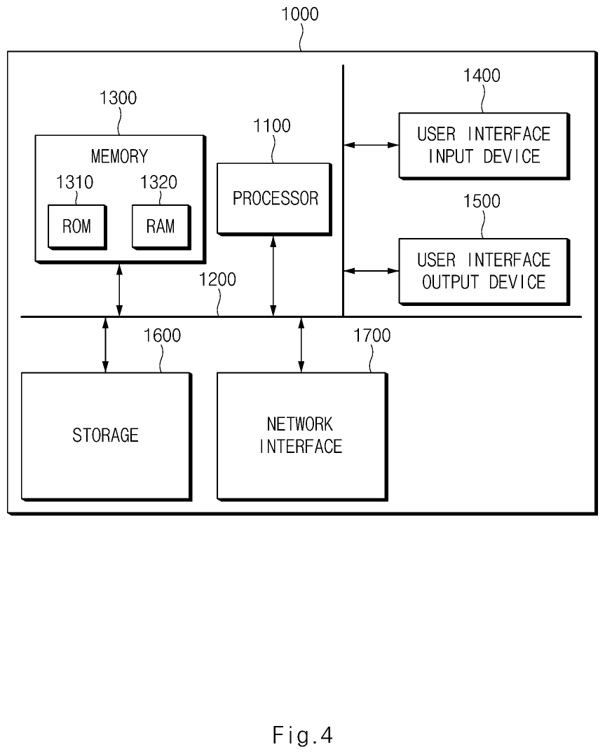

FIG. 4 is a block diagram illustrating a computing system for executing a method of switching control authority of an autonomous vehicle according to an exemplary embodiment of the present disclosure. Referring to FIG. 4, a computing system 1000 may include at least one processor 1100, a memory 1300, a user interface input device 1400, a user interface output device 1500, storage 1600, and a network interface 1700 connected through a system bus 1200. The processor 1100 may be a central processing unit (CPU), or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the present disclosure, the apparatus for switching driving control authority of an autonomous vehicle and the method thereof are capable of deep learning a normal driving pattern of the autonomous vehicle corresponding to a driving situation, detecting a matching degree of the driving pattern of a driver based on the deep learning result, and determining whether to retrieve the driving control authority of the driver corresponding to the detected matching degree, such that the driving control authority of the driver is retrieved to prevent an accident in advance even if there is no request to activate an autonomous driving mode of the driver.

The above description is a simple exemplification of the technical spirit of the present disclosure, and the present disclosure may be variously corrected and modified by those skilled in the art to which the present disclosure pertains without departing from the essential features of the present disclosure. Therefore, the disclosed exemplary embodiments of the present disclosure do not limit the technical spirit of the present disclosure but are illustrative, and the scope of the technical spirit of the present disclosure is not limited by the exemplary embodiments of the present disclosure. The scope of the present disclosure should be construed by the claims, and it will be understood that all the technical spirits within the equivalent range fall within the scope of the present disclosure.

What is claimed is:

1. An apparatus for switching driving control authority of an autonomous vehicle, comprising:
a learning device configured to deeply learn a normal driving pattern of the autonomous vehicle corresponding to a driving situation; and
a controller configured to determine whether to retrieve the driving control authority of a driver based on a learning result of the learning device.

2. The apparatus of claim 1, further comprising:
a storage configured to store a normal driving pattern model as the learning result of the learning device.

3. The apparatus of claim 2, wherein the controller is configured to detect a matching degree indicating a degree to which a driving pattern of the driver matches the normal driving pattern model, and retrieve the driving control authority of the driver when the detected matching degree is less than a first reference value.

4. The apparatus of claim 3, wherein the controller is configured to retrieve the driving control authority of the driver when an operational design domain (ODD) condition is met.

5. The apparatus of claim 3, wherein the controller is configured to correct a driving control value of the driver when the detected matching degree exceeds the first reference value but is less than a second reference value.

6. The apparatus of claim 5, wherein the controller is configured to correct a lateral control value or a longitudinal control value of the driver.

7. A method of switching driving control authority of an autonomous vehicle, comprising:
deeply learning, by a learning device, a normal driving pattern of the autonomous vehicle corresponding to a driving situation; and
determining, by a controller, whether to retrieve the driving control authority of a driver based on a learning result of the learning device.

8. The method of claim 7, further comprising:
storing, by a storage, a normal driving pattern model as the learning result of the learning device.

9. The method of claim 8, wherein the determining of whether to retrieve the driving control authority includes:
detecting, by the controller, a matching degree indicating a degree to which a driving pattern of the driver matches the normal driving pattern model; and
retrieving, by the controller, the driving control authority of the driver when the detected matching degree is less than a first reference value.

10. The method of claim 9, wherein the retrieving of the driving control authority includes:
determining, by the controller, whether an operational design domain (ODD) condition is met; and
retrieving, by the controller, the driving control authority of the driver when the ODD condition is met and the detected matching degree is less than a first reference value.

11. The method of claim 9, wherein the determining of whether to retrieve the driving control authority further includes:
correcting, by the controller, a driving control value of the driver when the detected matching degree exceeds the first reference value but is less than a second reference value.

12. The method of claim 11, wherein the correcting of the driving control value of the driver includes:
correcting, by the controller, a lateral control value or a longitudinal control value of the driver.
